(19) United States
(12) Patent Application Publication
(10) Pub. No.: US 2025/0324931 A1
(43) Pub. Date: Oct. 23, 2025

(54) Pressure Sensing Irrigation Devices And Related Methods

(71) Applicant: Rain Bird Corporation, Azusa, CA (US)

(72) Inventors: Randall Dennis Bousfield, Tucson, AZ (US); Michael A. McAfee, Tucson, AZ (US)

(21) Appl. No.: 18/642,411

(22) Filed: Apr. 22, 2024

(51) Int. Cl. A01G 25/16; A01G 25/02

(52) U.S. Cl. CPC A01G 25/165; A01G 25/02

(57) ABSTRACT

An irrigation device is provided including a body and a pressure sensor. The body is to be fluidly connected to an irrigation line of an irrigation system operable to move fluid from a water source to one or more water emitting devices to provide irrigation. The irrigation device is to be fluidly connected to the irrigation line to receive pressurized fluid from the water source during an irrigation cycle. The pressure sensor is mounted to the body to measure pressure in an interior of the irrigation line during the irrigation cycle to detect whether the body has a normal irrigation pressure condition or an abnormal irrigation pressure condition. The pressure sensor has communication circuitry to wirelessly communicate pressure data to a remote computing device to indicate whether the body has the normal irrigation pressure condition or the abnormal irrigation pressure condition.

### FIELD

This disclosure relates to irrigation devices and, in particular, to irrigation devices and methods for detecting problems with an irrigation system.

### BACKGROUND

Irrigation systems have water lines (e.g., hoses) that provide water from a water source to water emitting equipment, such as sprinklers and/or drip emitters. Over time, the irrigation system may develop problems, such as water leaks or blockages. For example, a crack may form in a hose or debris may clog the hose or water emitting equipment. A water leak can cause water to be wasted and the irrigation system to use more water than usual. A water leak or blockage may cause a reduction in the pressure in the water line downstream of the water leak or blockage, resulting in insufficient watering at the downstream water emitting equipment.

Detecting problems with an irrigation system can be difficult and problems may go unnoticed for extended periods of time. A user may determine there is a problem with an irrigation system, for example, upon receiving a water bill (e.g., showing an abnormal increase in water usage) or upon noticing underwatered plants. In agricultural settings, problems with the irrigation system are often monitored by having individuals trace the water lines to look for excessive amounts of water along the water lines. In another approach, a user may meter the water flow to the irrigation system to determine whether the water flow is too high (e.g., indicating a leak) or too low (e.g., indicating a block). The shortcoming of this approach is that the water flow must be outside of specified limits to identify a problem with the irrigation system. Additionally, the user still needs to find the location of the problem in the irrigation system. In commercial settings, for example, on a golf course, a user may connect a pressure measuring device at various points of the irrigation system to check the water pressure throughout the irrigation system. The pressure measuring device needs to be physically connected and then disconnected from the irrigation system at each point to measure the pressure, which can take a significant amount of time. Detecting problems with an irrigation system is further complicated where portions of the irrigation system (e.g., waterlines) are underground.

In any of the conventional approaches, determining the source of the problem (e.g., the location of the water leak or blockage) can be difficult and time consuming. The larger the scale of the irrigation system, the more tedious and difficult it can be to determine the location of the problem, especially in large scale irrigations system with many watering zones and emission devices and many and lengthy water lines.

### BRIEF DESCRIPTION OF THE DRAWINGS

FIG. 1 is a perspective view of an end plug having a pressure sensor.

FIG. 2 is a cross-sectional view of the end plug of FIG. 1 showing the pressure sensor in the end plug.

FIG. 3 is a perspective view of the end plug of FIG. 1 connected to a tube connector.

FIG. 4 is a block diagram of the pressure sensor of the end plug of FIG. 1.

FIG. 5 is a block diagram of an RFID reader operable to retrieve pressure data from the pressure sensor of the end plug of FIG. 1.

FIG. 6 shows an example schematic diagram of an irrigation system having a plurality of water lines that terminate with the end plugs of FIG. 1.

FIG. 7 illustrates use of the RFID reader of FIG. 5 to locate a problem with the irrigation system of FIG. 6 by reading the pressure at the end plugs.

FIG. 8 is a perspective view of a tube connector having the pressure sensor of FIG. 4.

FIG. 9 is a cross-sectional view of the tube connector showing the pressure sensor in the tube connector.

FIG. 10 illustrates use of the RFID reader of FIG. 5 to locate a problem with an irrigation system having a plurality of water lines that each include several tube connectors of FIG. 8.

FIG. 11 is a perspective view of a rotor sprinkler having the pressure sensor of FIG. 4.

FIG. 12 is a cross-sectional view of the rotor sprinkler of FIG. 11, with some internal components omitted for clarity, showing the pressure sensor in the rotor sprinkler.

FIG. 13 illustrates the RFID reader being used to retrieve pressure data from the pressure sensor of the rotor sprinkler of FIG. 11.

### DETAILED DESCRIPTION

This disclosure provides irrigation devices that include a pressure sensor to measure the pressure in an irrigation system. The irrigation devices having the pressure sensor described in this disclosure include an end plug 100, a tube connector 200, and a rotor sprinkler or rotor 300; however, other types of irrigation devices may similarly include such a pressure sensor, including, as examples, drip line, emitters, valves, filters, and regulators. The pressure sensor may be mounted to the irrigation device and positioned to measure pressure in the interior of the irrigation system to detect whether the irrigation system has a normal irrigation pressure condition or an abnormal irrigation pressure condition. The abnormal irrigation pressure condition may indicate a problem with the irrigation system, for example, a blockage or a leak.

The pressure sensor may be a Radio Frequency Identification (RFID) pressure sensor having an RFID chip that measures pressure and sends pressure data to an RFID reader responsive to receiving a signal from the RFID reader. The pressure sensor may thus be wireless and powered by the signal from the RFID reader to measure and send the pressure data. The pressure sensor thus does not need a power source (e.g., a battery), which minimizes maintenance of the irrigation device. A user may use the RFID reader to wirelessly read the pressure at an irrigation device having the pressure sensor to determine whether the pressure in the irrigation system at the irrigation device is proper. For example, the user may use the RFID reader to quickly diagnose and locate the source of a leak or blockage in the irrigation system by detecting locations of improper pressure in the irrigation system. As another example, during setup of an irrigation system, the user may use the RFID reader to check to make sure the pressure is proper at the irrigation devices and may adjust the irrigation system upon detecting improper pressure at an irrigation device.

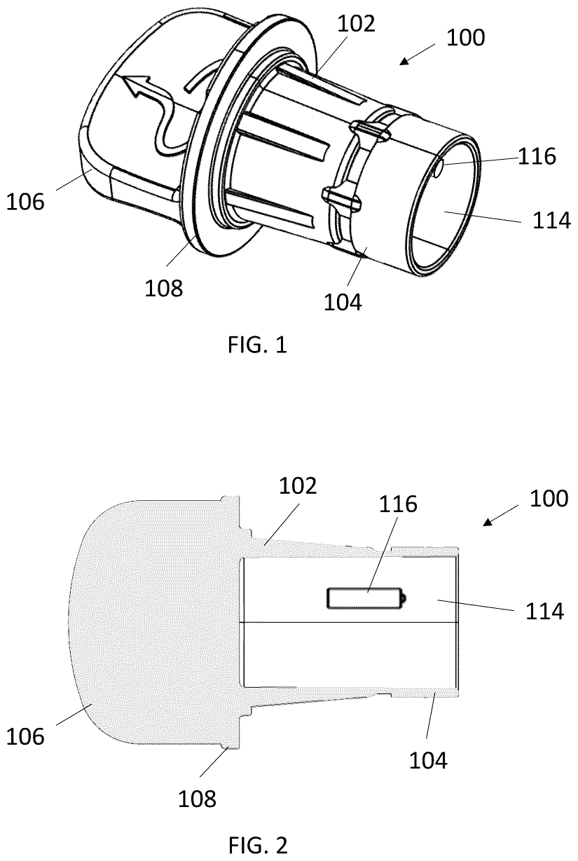

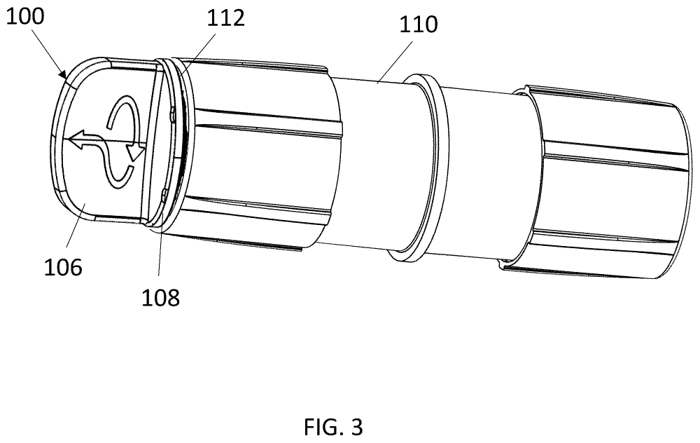

With respect to FIGS. 1-2, the end plug 100 has a body 102 including an insertion portion 104, a grasping portion 106, and a flange 108 between the insertion portion 104 and the grasping portion 106. The end plug 100 may be inserted into the end of an irrigation line to terminate the irrigation line. With reference also to FIG. 3, the insertion portion 104 of the end plug 100 may be urged into an end 112 of a tube connector 110 to close the tube connector 110 and inhibit fluid from flowing through the tube connector 110, e.g., from a tube connected to the other end of the tube connector 110. The insertion portion 104 of the end plug 100 may be inserted into the end 112 of the tube connector 110 until the flange 108 contacts the tube connector 110. The flange 108 inhibits the end plug 100 from being over inserted into the tube connector 110. The grasping portion 106 may be flat to permit the user to twist the end plug 100 relative to the tube connector 110 to lock it to or unlock it from the tube connector 110.

The insertion portion 104 of the end plug 100 defines an interior chamber 114. When inserted into the tube connector 110, the interior chamber 114 is exposed to fluid in the tube connector 110 and thus the irrigation line. The end plug 100 includes a pressure sensor 116 mounted to the body 102 of the end plug 100 such that the pressure sensor 116 is able to measure pressure in the interior chamber of the end plug 100. For example, the pressure sensor 116 may be mounted to the insertion portion 104 in the interior chamber 114 of the end plug 100. The pressure sensor 116 may be secured to the insertion portion 104 by an adhesive, such as cyanoacrylate. As another example, the pressure sensor 116 may be embedded in the body 102 of the end plug 100. For instance, the end plug 100 may be molded over the pressure sensor 116 with the pressure sensor 116 exposed to the interior chamber 114 to measure the pressure in the interior chamber 114. In other forms, the pressure sensor 116 is mechanically fastened to the body 102 of the end plug 100. For example, the body 102 may include a clip (e.g., a clip molded as a single piece with the body 102) that the pressure sensor 116 snaps into.

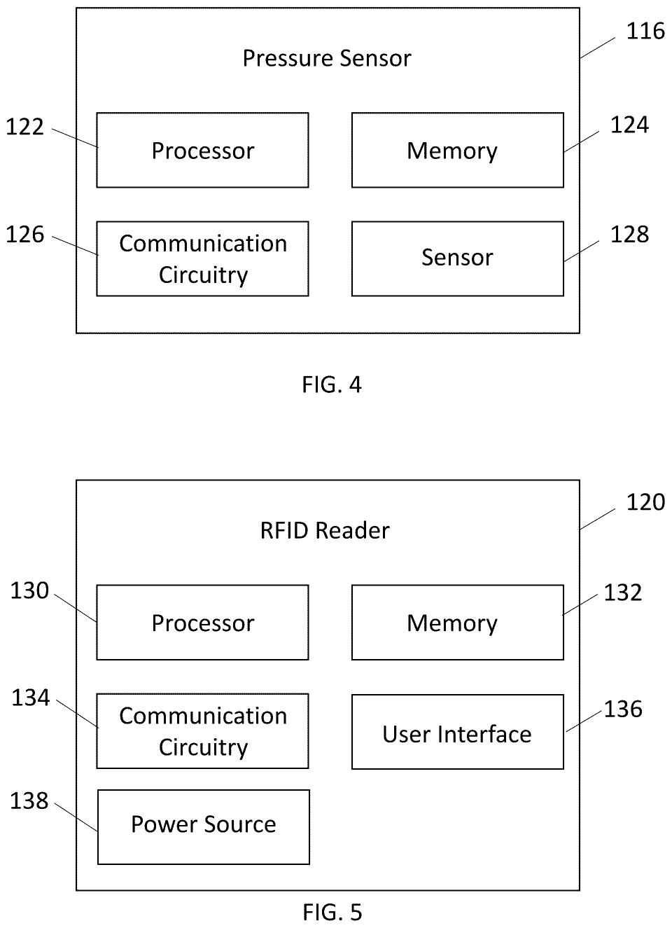

With respect to FIG. 4, the pressure sensor 116 may be configured to wirelessly communicate with a remote computing device (e.g., a smartphone, mobile user device, etc.) to send pressure data to the remote device. The pressure sensor 116 may be small and compact to minimize the interruption of fluid flow about the pressure sensor 116 when mounted in the irrigation device. The pressure sensor 116 may be an (RFID) pressure sensor 116 having an RFID chip that collects pressure data and transmits the pressure data in response to a signal from an RFID reader 120. The pressure sensor 116 may include a processor 122, a memory 124, communication circuitry 126, and a sensor 128. The sensor 128 of the pressure sensor 116 may be, as examples, a capacitive pressure sensor or a piezoresistive strain gauge sensor. The processor 122 may be configured to execute instructions stored in the memory 124 to cause the sensor 128 to collect pressure data and to cause the communication circuitry 126 to wirelessly transmit the pressure data, e.g., to the RFID reader 120. The memory 124 may be low-power, non-volatile memory that store programs and/or instructions for the processor 122 to execute responsive to receiving an interrogation signal from the RFID reader 120. The memory 124 also may be used to store sensed data. The communication circuitry 126 may include an antenna that receives an interrogation signal from the RFID reader 120. Upon receiving the interrogation signal, the processor 122 causes the pressure sensor 116 to collect and send pressure data to the RFID reader 120 and store the sensed pressure data on the memory 124. As one example, the pressure sensor 116 may be ultra-miniature, low frequency RFID passive wireless pressure and temperature sensor (SKU: LFR-TPN1-0900-00) from Phase IV Engineering, Inc. in Boulder, Colorado.

The pressure sensor 116 may be a passive RFID device that does not include a separate power source. Where the pressure sensor 116 is a passive RFID, the pressure sensor 116 may receive its electrical power from the RFID reader 120 via the antenna of the communication circuitry 126. Specifically, the electromagnetic waves of the interrogation signal of the RFID reader 120 induce a current in the antenna of the communication circuitry 126 that powers the pressure sensor 116 for a period to collect pressure data of the interior chamber 114 and transmit the pressure data to the RFID reader 120. A benefit of using a passive RFID pressure sensor 116 is that the pressure sensor 116 does not increase the maintenance of the end plug 100, e.g., to replace a battery. In some forms, the pressure sensor 116 may be an active RFID that includes a power source, such as a battery, to electrically power the pressure sensor 116 to collect and send the pressure data responsive to the interrogation signal of the RFID reader 120. A benefit to using an active RFID pressure sensor is that the pressure sensor 116 may be able to communicate over longer distances, enabling a user to check the pressure from further away or from multiple end plugs at one time. It also may enable sending pressure data on a routine basis or when there is a meaningful change.

The pressure data collected by the pressure sensor 116 may indicate whether the irrigation system has a normal irrigation pressure condition or an abnormal irrigation pressure condition. The normal irrigation pressure condition may be determined to exist when the measured pressure is in a range of normal pressures. For example, the desired irrigation pressure value (e.g., 30 psi or 45 psi)+/−3 psi. The abnormal irrigation pressure condition may be determined to exist when the measured pressure is outside of the range of normal pressures. The presence of an abnormal irrigation pressure condition may indicate that the irrigation system has a problem, such as a blockage or a leak in the irrigation line to which the end plug 100 is mounted. For example, where the pressure is too low or below the range of normal pressures, there may be a blockage or leakage in the irrigation line upstream of the end plug 100.

With respect to FIG. 5, the RFID reader 120 is configured to send an interrogation signal to cause the pressure sensor 116 to collect and transmit pressure data. The RFID reader 120 receives the pressure data transmitted from the pressure sensor 116. The RFID reader 120 may present the pressure data to the user for evaluation. The RFID reader 120 includes a processor 130, a memory 132, communication circuitry 134, a user interface 136, and a power source 138. The power source 138 may be, for example, a battery that provides electrical power to the electrical components of the RFID reader 120. The processor 130 may be configured to execute instructions stored in memory 132 to provide functionality to the RFID reader 120. For example, the processor 130 may receive input from a user via the user interface 136 to retrieve pressure data from an irrigation device, such as the end plug 100. The processor 130 may cause the communication circuitry 134 to transmit an interrogation signal to prompt the pressure sensor 116 of the end plug 100 to collect and send pressure data to the RFID reader 120. The communication circuitry 134 may draw electrical power from the power source 138 to send the interrogation signal and the interrogation signal may provide electrical power to the pressure sensor 116. The processor 130 may receive, via the communication circuitry 134, a communication signal from the pressure sensor 116 of the end plug 100, including the pressure data collected by the pressure sensor 116. The processor 130 may store the pressure data in the memory 132.

The processor 130 may present information pertaining to the received pressure data to the user via the user interface 136. For example, the processor 130 may present a pressure value and/or an indication whether the pressure is acceptable, e.g., a normal irrigation pressure condition or an abnormal irrigation pressure condition. The user interface 136 may include, as examples, a display screen (e.g., a touchscreen display), one or more buttons, a microphone, and/or a speaker. The processor 130 may receive input from the user, e.g., to retrieve pressure data from an irrigation device, via the touchscreen display, a button, or the microphone. The processor 130 may present information to the user, e.g., the information pertaining to the received pressure data, via the display screen or the speaker.

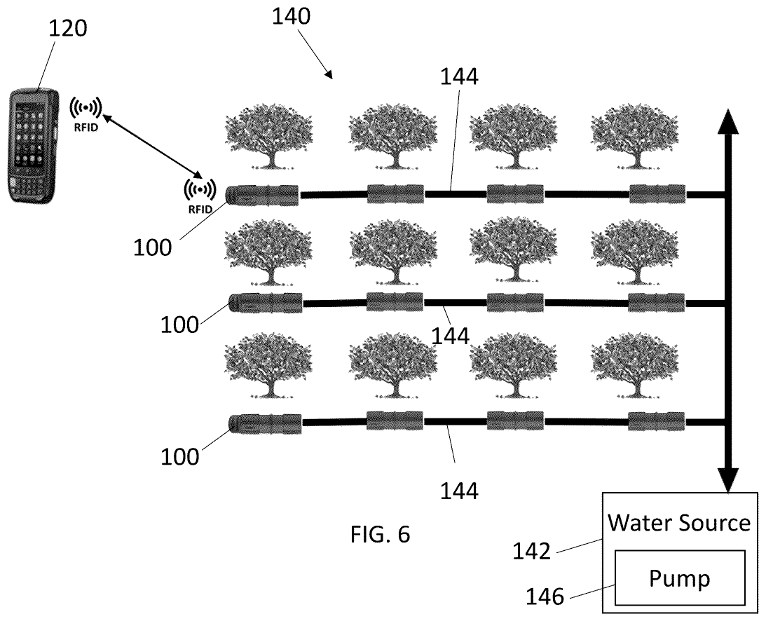

With respect to FIG. 6, an example irrigation system 140 is shown having a water source 142 and a plurality of irrigation lines 144 connected to the water source 142. The water source 142 may include a pump 146 operable to force water along the irrigation lines 144 at a desired pressure. The irrigation lines 144 may extend from the water source 142 to water various zones to provide water to an area or plants. The end plug 100 closes the ends of the irrigation lines 144 to form the terminal end of the irrigation lines 144. The irrigation lines 144 may be at least partially buried in the ground.

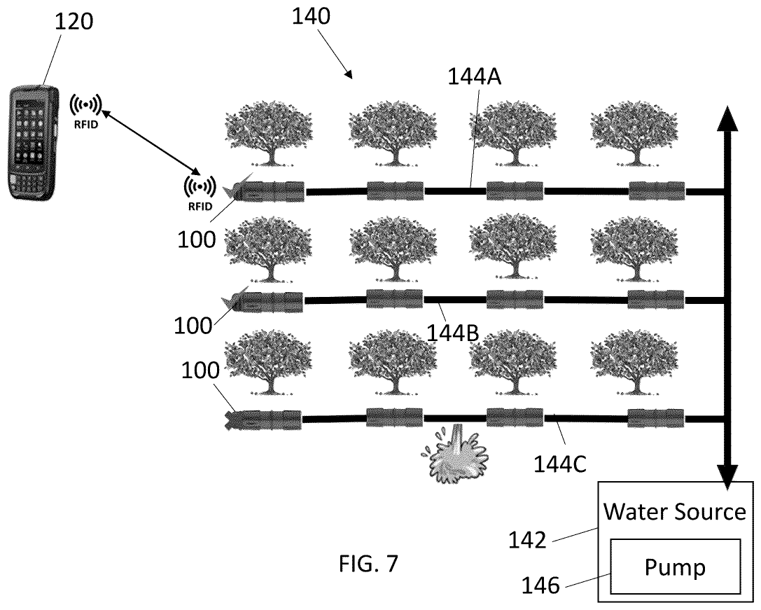

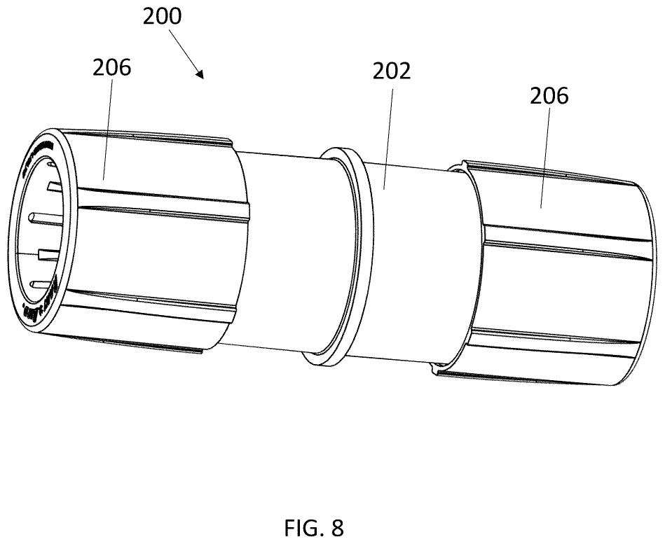

With respect also to FIG. 7, the RFID reader 120 may be used to determine the pressure at the terminal ends of each irrigation line 144A, 144B, 144C of the irrigation system 140 by communicating with the pressure sensors 116 of the end plugs 100 as discussed above. For example, a user may periodically check the pressure at the ends of the irrigation lines to ensure the irrigation system 140 is working properly. Or, the user may check the pressure at the ends of the irrigation lines upon determining there is an issue with the irrigation system 140, for example, the irrigation system 140 is using too much water or certain areas or plants appear underwatered or overwatered. By reading the pressure at the end of an irrigation line 144, the user can determine whether there is a problem along that irrigation line 144. If the pressure is proper (e.g., a normal irrigation pressure condition) at the end plug 100 of the irrigation line 144 as indicated at irrigation lines 144A and 144B of FIG. 7, then the user can determine that the irrigation lines 144A and 144B are working properly and need not trace the length of such lines to search for a problem. Where the pressure at the end plug 100 of an irrigation line 144 is improper (e.g., an abnormal irrigation pressure condition), as illustrated at irrigation line 144C in FIG. 7, the user is able to determine that irrigation line 144C has a problem and search for the problem along that irrigation line 144C (e.g., a leak or block). In FIG. 7, the irrigation line 144C includes a leak. Thus, measuring the pressure of the end plugs 100 of the irrigation lines 144 quickly narrows the search for the problem and can save the user time in searching for a problem with an irrigation system 140, which can span many acres. For instance, the user can quickly determine that the irrigation lines 144A and 144B are functioning properly with quick measurements with the RFID reader 120 and move on to check other irrigation lines 144 such as irrigation line 144C. Wirelessly reading the pressure of the end plugs 100 is particularly beneficial where the irrigation lines 144 and/or the end plugs 100 are buried underground. The pressure may quickly be determined using the RFID reader 120 without having to unbury the end plug 100 to determine the pressure.

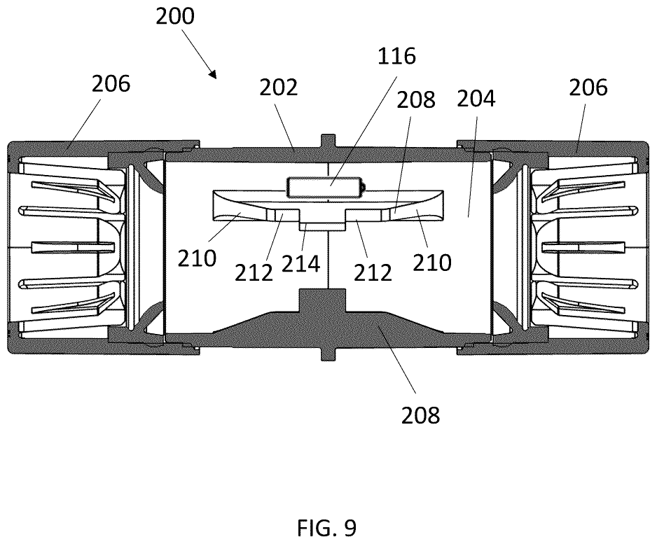

With respect to FIGS. 8 and 9, a tube connector 200 is provided that includes the pressure sensor 116 described above. The tube connector 200 includes a central body 202 defining an interior chamber 204 forming a flow path therethrough. The tube connector 200 includes couplers 206 mounted on each end of the body 202. Tubes may be inserted into the respective couplers 206 to secure the tubes to the tube connector 200 with a fluid tight connection to permit fluid to flow from one tube to the other through the tube connector 200. The couplers 206 also retain the tubes to inhibit the tubes from being unintentionally withdrawn from the couplers 206. The tube connector 200 is thus able to fluidly connect and secure one tube to another tube without fluid leakage or separation.

The central body 202 includes a plurality of elongated axially extending guide ramps 208 that extend inward into the interior chamber 204. In the embodiment shown, the central body 202 includes three guide ramps 208 which may be at approximate equiangular intervals about the interior chamber 204. The guide ramps 208 center and retain the ends of the tubes press-fitted into the couplers 206 of the tube connector 200 in substantial axial alignment. Each guide ramp 208 has ramped ends 210 that taper radially inwardly to an axially extending portion 212 that includes a centrally positioned stop or tab 214. The ramped ends 210 of the guide ramps 208 direct the end portion of the tubes toward the center of the central body 202 as the tubes are inserted into the body 202. The tabs 214 limit insertion of the tube into the tube connector 200. As discussed above, the end plug 100 may be inserted into the tube connector 200 instead of a tube to terminate the irrigation line.

The tube connector 200 includes the pressure sensor 116. The pressure sensor 116 is mounted to the tube connector 200 to measure pressure of the interior chamber 204. In the form shown, the pressure sensor 116 is mounted in the interior chamber 204 of the tube connector 200 adjacent one of the guide ramps 208. The sensor 128 of the pressure sensor 116 is exposed to the water in the tube connector 200 (e.g., that flows between two tubes connected by the tube connector 200) to measure the water pressure. The pressure sensor 116 may be secured to the central body 202 by an adhesive, such as cyanoacrylate. In some forms, the pressure sensor 116 may be embedded in the central body 202 of the tube connector 200. For instance, the central body 202 may be molded over the pressure sensor 116 with at least the sensor 128 exposed to the interior chamber 204 to measure pressure in the interior chamber 204. In other forms, the pressure sensor 116 is mechanically fastened to the central body 202 of the tube connector 200. For example, the central body 202 may include a clip (e.g., a clip molded as a single piece with the body 202) that the pressure sensor 116 snaps into. The pressure sensor 116 may be used to measure the pressure in the tube connector 200 to detect whether the tube connector 200 has the normal irrigation pressure condition or the abnormal irrigation pressure condition similar to the end plug 100 discussed above. The tube connector 200 may be mounted upstream of the terminal end of the irrigation line which aids to indicate the location of the problem when the abnormal irrigation pressure condition is present. For example, where the pressure is too low or below the range of normal pressures, there may be a blockage or leakage in the irrigation line upstream of the tube connector 200. Where the pressure is too high or above the range of normal pressures, there may be a blockage in the irrigation line downstream of the tube connector 200.

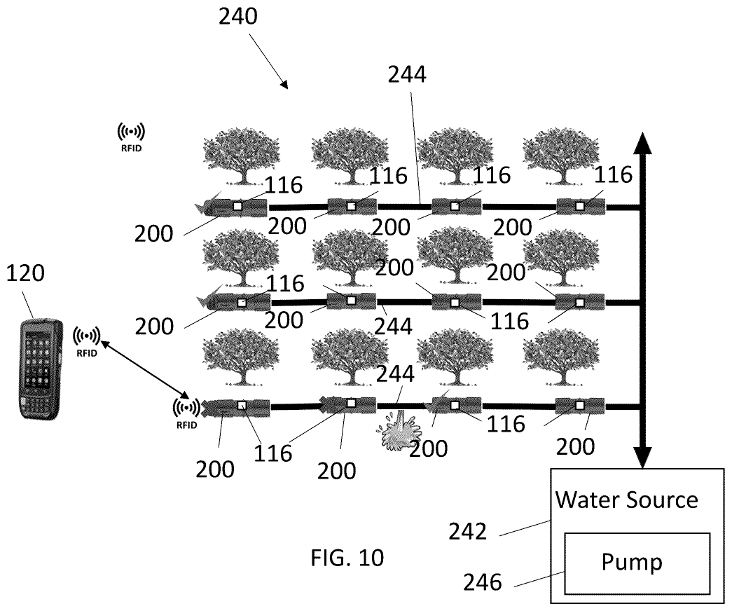

With respect to FIG. 10, an example irrigation system 240 is shown having a water source 242 and a plurality of irrigation lines 244 connected to the water source 242 like the irrigation system 140 discussed above. In the irrigation system 240, the irrigation lines 244 include the tube connectors 200 having the pressure sensors 116 along the irrigation lines 244. The tube connectors 200 may be used in addition to or alternatively to the end plugs 100. The RFID reader 120 may be used to determine the pressure at the tube connectors 200 of the irrigation lines 244 by communicating with the pressure sensors 116 of the tube connectors 200. For instance, a user may use the RFID reader 120 to check the pressure at various points along one of the irrigation lines 244. For example, upon determining one of the irrigation lines 244 has a problem (e.g., a blockage or leak), the user may measure the pressure at the tube connectors 200 along the irrigation line to determine what portions of the irrigation line have proper or improper pressure to identify the location of the problem. The user may determine whether an irrigation line 244 has a problem by measuring the pressure at the end plug 100 or a tube connector 200 at the end of the irrigation line as discussed above. Upon detecting an irrigation line 244 has a problem, the user may begin measuring the pressure of the tube connectors 200 along the irrigation line 244 to locate the location of the problem. Where an upstream tube connector 200 has proper water pressure and the adjacent downstream tube connector 200 has improper water pressure, the user may determine the problem is between the two tube connectors 200. Providing the pressure sensor 116 in the tube connector 200 permits the user to quickly measure the pressure along the irrigation lines 144 using the RFID reader 120 so that the user can quickly narrow down the location of the problem, even if the tube connector 200 is underground. In this case, there is a leak between the last and second to last connector 200.

While FIG. 10 shows all of the tube connectors 200 of the irrigation system 240 as having the pressure sensor 116, in other forms some of the tube connectors may be conventional tube connectors. For example, each irrigation line 244 may have a tube connector 200 at the end of the irrigation line 244 for quickly determining whether the irrigation line 244 is functioning properly or has a problem like the end plug 100 discussed above. As another example, every other tube connector along the irrigation line 244 has the pressure sensor 116 to permit the user to narrow down the source of the problem, but with less precision than where all the tube connectors have the pressure sensor 116.

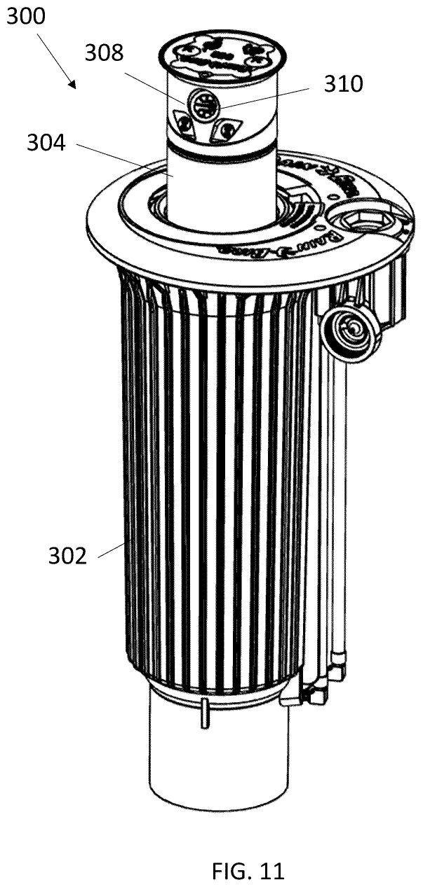

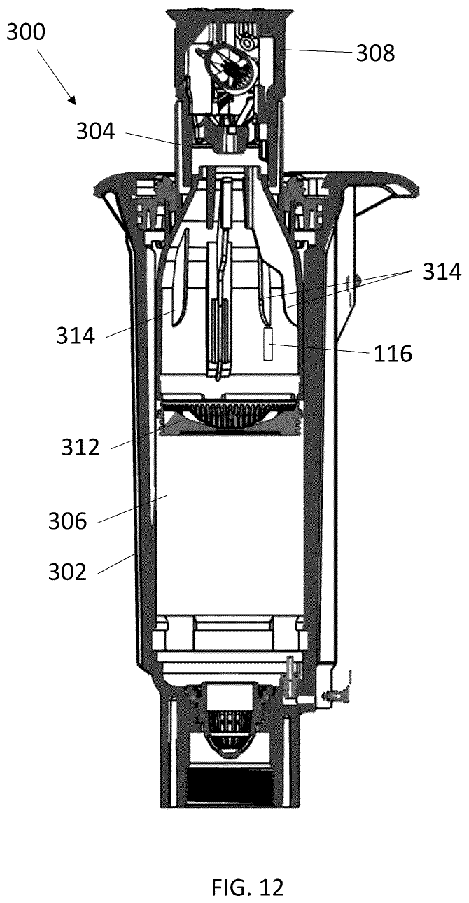

With respect to FIGS. 11-12, the rotor 300 includes a housing 302 and a riser 304 that reciprocates in and out of the housing 302. For example, when water pressure in an interior 306 of the housing 302 exceeds a threshold, the water pressure forces the riser 304 to the extended position. A rotor nozzle 308 is mounted to the riser 304 and is supported above the housing 302 when the riser 304 is moved to the extended position. The rotor nozzle 308 includes an outlet 310 through which water is ejected from the rotor 300. The riser 304 may include a screen 312 mounted to the inlet end of the riser 304 to inhibit debris from entering the riser 304. The water flows into the housing 302, through the screen 312 and into the riser 304, through a turbine (not shown for clarity) and along the riser 304 to the rotor nozzle 308. The interior of the riser 304 may include ribs 314 to provide rigidity to the riser 304 and direct the flow of water toward the rotor nozzle 308. The flow of the water through the turbine causes the rotor nozzle 308 to rotate and spin the outlet 310 relative to the riser 304.

The rotor 300 further includes the pressure sensor 116 mounted in the riser 304 to measure the pressure in the riser 304. The sensor 128 of the pressure sensor 116 is exposed to the water in the interior 306 of the rotor 300 (e.g., that flows from the housing 302 to the rotor nozzle 308) to measure the water pressure. The pressure sensor 116 may thus be used to determine whether the rotor 300 has a normal irrigation pressure condition or an abnormal irrigation pressure condition. The pressure sensor 116 may be mounted adjacent to or inline with one of the ribs 314 of the riser 304 which may, for example, minimize the disturbance to the water flow through the riser 304. The pressure sensor 116 may be secured to the riser 304 by an adhesive, such as cyanoacrylate. In some forms, the pressure sensor 116 may be embedded in the riser 304. For instance, the riser 304 may be molded over the pressure sensor 116 with at least the sensor 128 exposed to the interior of the riser 304 to measure the pressure in the riser 304. In other forms, the pressure sensor 116 is mechanically fastened to the riser 304. For example, the riser 304 may include a clip (e.g., a clip molded as a single piece with the riser 304) that the pressure sensor 116 snaps into. The pressure sensor 116 may also be mounted at other locations in the rotor 300 where the pressure sensor 116 is able to measure the pressure of the rotor 300 and communicate with the RFID reader 120. Where the rotor 300 is at least partially buried in the ground, mounting the pressure sensor 116 to an upper portion of the rotor 300 may reduce interference and improve communications between the pressure sensor 116 and the RFID reader 120.

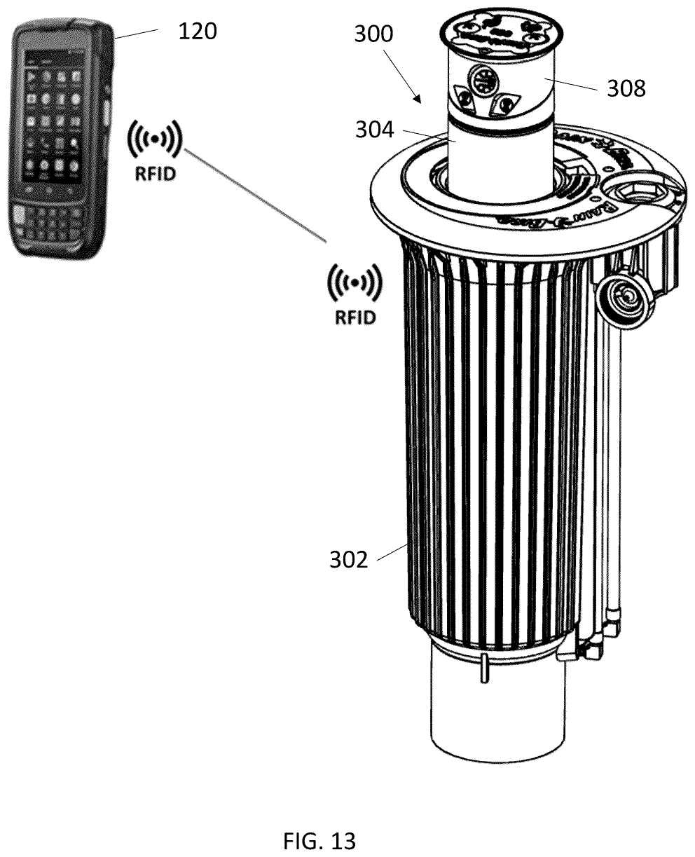

With respect to FIG. 13, the RFID reader 120 may be used to read the pressure of the rotor 300 by communicating with the pressure sensor 116 as discussed above. In certain applications, such as a golf course irrigation system, it is beneficial to know the case pressure of a rotor 300 to set up the irrigation system correctly (e.g., with sufficient water pressure at each of the rotors 300 of the irrigation system). Thus, the case pressure of the rotor 300 may be quickly read using the RFID reader 120. Where the pressure is improper, the installer may make adjustments to the irrigation system (e.g., adjusting the pressure provided by the water source) to bring the rotor 300 to the proper pressure. Use of the pressure sensor 116 in the rotor 300 and the RFID reader 120 to measure the case pressure of the rotor 300 saves the installer a significant amount of time compared to conventional approaches where the installer must remove the rotor, attach pressure reading equipment to the irrigation line to read the pressure, and then reinstall the rotor. Also, because the pressure is measured when the rotor 300 is operating, use of the RFID reader 120 to measure the pressure of the rotor 300 permits the pressure to be measured at a distance. The RFID reader 120 permits a user to quickly measure the pressure of many rotors 300 during a regular irrigation cycle.

In some embodiments, one or more wireless readers may be mounted about the irrigation system to retrieve pressure data from the irrigation devices, e.g., without the need for an individual to travel about the irrigation system to collect the pressure data. For example, the wireless readers may periodically retrieve pressure data from one or more irrigation devices. In some forms, the irrigation devices (e.g., rotors 300) include the wireless reader. The wireless readers may include a power source (e.g., a battery or a power grid connection) and have communication circuitry to communicate with the pressure sensors 116 and a remote computing device. The wireless readers may communicate pressure data retrieved from the irrigation devices to a remote computing device. For instance, the wireless readers may communicate all pressure data retrieved to a remote computing device for storage and/or analysis. In some forms, the wireless reader is programmed to send pressure data of an irrigation device upon detecting a change or an abnormal pressure condition. A user may access and view the pressure data sent from the wireless readers of the irrigation system to the remote computing device without having to travel about the irrigation system to collect the data. The user may detect an abnormal pressure condition upon review of the pressure data and travel to the location of the abnormal pressure condition to investigate a problem.

The end plug 100, tube connector 200, and rotor 300 are examples of irrigation devices that could incorporate the pressure sensor 116. Those having skill in the art will appreciate that other irrigation devices could similarly include the pressure sensor 116 to enable a user to quickly ascertain the pressure at such irrigation device as described above. As non-limiting examples, the irrigation devices having the pressure sensor 116 could include, other types of sprinklers (e.g., a spray body), drip line, emitters, valves, filters, tubing, pumps, and regulators.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. An irrigation device for an irrigation system operable to move fluid from a water source toward one or more water emitting devices to provide irrigation, the irrigation device comprising:
a body to be fluidly connected to an irrigation line of the irrigation system to receive pressurized fluid from the water source during an irrigation cycle; and
a pressure sensor mounted to the body to measure pressure in an interior of the irrigation line during the irrigation cycle to detect whether the body has a normal irrigation pressure condition or an abnormal irrigation pressure condition, the pressure sensor having communication circuitry to wirelessly communicate pressure data to a remote computing device to indicate whether the body has the normal irrigation pressure condition or the abnormal irrigation pressure condition.

2. The irrigation device of claim 1 wherein the normal irrigation pressure condition exists when the pressure is in a range of normal pressures and the abnormal irrigation pressure condition exists when the pressure is outside of the range of normal pressures.

3. The irrigation device of claim 1 wherein the abnormal irrigation pressure condition is indicative of a problem with the irrigation system.

4. The irrigation device of claim 3 wherein the problem with the irrigation system includes at least one of a blockage and a leak along the irrigation line.

5. The irrigation device of claim 1 wherein the pressure sensor is an RFID pressure sensor operable to measure pressure responsive to a signal of an RFID reader.

6. The irrigation device of claim 5 wherein the RFID pressure sensor is electrically powered by the signal of the RFID reader.

7. The irrigation device of claim 1 wherein the pressure sensor is configured to:
receive a signal from a user device via the communication circuitry;
measure the pressure of the interior of the irrigation system responsive to the signal; and
send pressure data to the remote computing device via the communication circuitry based on the measured pressure.

8. The irrigation device of claim 1 wherein the pressure sensor is secured to an interior of the body.

9. The irrigation device of claim 1 wherein the pressure sensor is at least partially embedded in the body.

10. The irrigation device of claim 1 wherein the body forms at least a portion of an irrigation line end plug.

11. The irrigation device of claim 1 wherein the body forms at least a portion of tube connector.

12. The irrigation device of claim 1 wherein the body includes a sprinkler body including:
a housing having an inlet connectable to an irrigation system; and
a riser movable relative to the housing between a retracted position and an extended position.

13. A method of measuring water pressure at an irrigation device of an irrigation system operable to move fluid from a water source toward one or more water emitting devices to provide irrigation, the method comprising:
at a pressure sensor mounted to the irrigation device to measure pressure of an interior of the irrigation system during an irrigation cycle to detect whether the irrigation system has a normal irrigation pressure condition or an abnormal irrigation pressure condition at the irrigation device, the pressure sensor having communication circuitry to wirelessly communicate with a remote device:
receiving a signal from the remote device via the communication circuitry;
measuring the pressure of the interior of the irrigation system responsive to the signal; and
sending pressure data of the interior of the irrigation system to the remote device via the communication circuitry to indicate whether the irrigation system has the normal irrigation pressure condition or the abnormal irrigation pressure condition at the irrigation device.

14. The method of claim 13 wherein the normal irrigation pressure condition exists when the pressure is in a range of normal pressures and the abnormal irrigation pressure condition exists when the pressure is outside of the range of normal pressures.

15. The method of claim 13 wherein the abnormal irrigation pressure condition is indicative of a problem with the irrigation system.

16. The method of claim 15 wherein the problem with the irrigation system includes at least one of a blockage and a leak.

17. The method of claim 13 wherein receiving the signal from the remote device includes using energy of the signal to electrically power the pressure sensor for the steps of measuring and sending.

18. The method of claim 13 wherein the pressure sensor is an RFID pressure sensor.

19. The method of claim 13 wherein the remote device includes an RFID reader and wherein receiving the signal from the remote device includes receiving an interrogation signal from the RFID reader.

20. The method of claim 13 wherein the pressure sensor is secured to an interior of the irrigation device.

21. The method of claim 13 wherein the irrigation device is one of:
an irrigation line end plug;
a tube connector;
a valve;
a dripline; and
a sprinkler.

22. An irrigation system comprising:
a plurality of irrigation devices to be mounted along one or more irrigation lines of the irrigation system to carry fluid from a water source toward one or more water emitting devices during an irrigation cycle, each irrigation device of the plurality of irrigation devices having a pressure sensor mounted thereto to measure pressure of the irrigation system at the irrigation device; and
a remote device configured to wirelessly communicate with the pressure sensors of the plurality of irrigation devices, the remote device operable to retrieve pressure data from a first irrigation device of the plurality of irrigation devices during the irrigation cycle to determine the pressure of the irrigation system at the first irrigation device to detect whether the irrigation system has a normal irrigation pressure condition or an abnormal irrigation pressure condition at the first irrigation device.

23. The irrigation system of claim 22 wherein the normal irrigation pressure condition exists when the pressure is in a range of normal pressures and the abnormal irrigation pressure condition exists when the pressure is outside of the range of normal pressures.

24. The irrigation device of claim 22 wherein the abnormal irrigation pressure condition is indicative of a problem with the irrigation system.

25. The irrigation system of claim 22 wherein the remote device is configured to:
send a first signal to cause a first pressure sensor of the first irrigation device to measure pressure in the first irrigation device; and
receive a second signal from the first pressure sensor including pressure data.

26. The irrigation system of claim 22 wherein the pressure sensors of the plurality of irrigation devices each include a passive RFID component.

27. The irrigation system of claim 22 wherein the plurality of irrigation devices include one or more of a sprinkler, an irrigation line end plug, a valve, a drip line, an irrigation line, and a tube connector.

28. An apparatus for detecting pressure of an irrigation system operable to move fluid from a water source toward one or more water emitting devices to provide irrigation, the apparatus comprising:
communication circuitry configured to wirelessly communicate with an irrigation device having a pressure sensor to measure the pressure of the irrigation system at the irrigation device; and
a processor operably coupled to the communication circuitry, the processor configured to:
wirelessly send a first signal to the irrigation device via the communication circuitry to cause the pressure sensor to measure the pressure of the irrigation system at the irrigation device; and
wirelessly receive a second signal from the irrigation device via the communication circuitry including pressure data of the irrigation system at the irrigation device, the pressure data indicating whether the irrigation system has a normal irrigation pressure condition or an abnormal irrigation pressure condition at the irrigation device.

29. The apparatus of claim 28 wherein the normal irrigation pressure condition exists when the pressure is in a range of normal pressures and the abnormal irrigation pressure condition exists when the pressure is outside of the range of normal pressures.

30. The apparatus of claim 28 wherein the abnormal irrigation pressure condition is indicative of a problem with the irrigation system.

31. The apparatus of claim 28 wherein the apparatus includes an RFID reader and the pressure sensor is an RFID pressure sensor of the irrigation device, wherein the first signal is an interrogation signal to cause the RFID pressure sensor to measure the pressure and send the pressure data.

32. The apparatus of claim 31 wherein the interrogation signal provides electrical power to the RFID pressure sensor of the irrigation device to cause measuring the pressure and send the pressure data indicative of the normal irrigation pressure condition or the abnormal irrigation pressure condition at the irrigation device.

33. The apparatus of claim 28 further comprising a user interface, wherein the processor is further configured to present the pressure data to the user via the user interface.

34. The apparatus of claim 28 further comprising a user interface, wherein the processor is further configured to receive input from a user via the user interface to retrieve pressure data from the irrigation device.
